(19) United States
(12) Patent Application Publication
(10) Pub. No.: US 2023/0035419 A1
(43) Pub. Date: Feb. 2, 2023

(54) STORAGE DEVICE AND SYSTEM FOR COUPLING TO A SIDE OF AN AUTOMOBILE

(71) Applicant: Stephen Womack, Cartersville, GA (US)

(72) Inventor: Stephen Womack, Cartersville, GA (US)

(21) Appl. No.: 17/387,374

(22) Filed: Jul. 28, 2021

(51) Int. Cl. B60R 9/02

(52) U.S. Cl. CPC B60R 9/02; F16B 45/00

(57) ABSTRACT

Various implementations include a storage device for coupling to a side of an automobile. The device includes a strap and at least one rack. The strap has a strap longitudinal axis, a first strap portion, and a second strap portion. The strap includes two or more strap attachment portions. The rack has a first component defining a first component surface and a second component defining a second component surface. A plane defined by the second component surface is transverse to a plane defined by the first component surface. The rack includes a rack attachment portion coupled to the first component. The first strap portion and second strap portion are removably couplable to portions of the automobile. The rack attachment portion is removably couplable to a strap attachment portion such that the first component surface faces the strap and the second component extends from the first component away from the strap.

### BACKGROUND

Some existing storage systems for automobiles allow for storing supplies on the top or the rear of an automobile. However, the tops of automobiles can be difficult to access, and the rears of automobiles are limited in space.

Existing side storage systems for automobiles allow for storing supplies along the side of an automobile which is both convenient and allow for longer supply lengths. However, these existing side storage systems can block one or more of the doors on the side of the automobile to which the system is coupled. For these systems, the storage system must be at least partially disassembled before the blocked doors can be used. Also, the existing side storage systems include unreliable and/or nonadjustable storage heights, which may not be suitable for all automobiles or supply types.

Thus, a need exists for a side storage system that allows for reliable and adjustable storage height and allows for accessibility of the doors on the side of the automobile to which the system is coupled.

### SUMMARY

Various implementations include a storage device for coupling to a side of an automobile. The device includes a strap and at least one rack. The strap has a strap longitudinal axis, a first strap portion, and a second strap portion opposite and spaced apart from the first strap portion along the strap longitudinal axis. The strap includes two or more strap attachment portions spaced apart from each other along the strap longitudinal axis. The at least one rack has a first component defining a first component surface and a second component defining a second component surface. A plane defined by the second component surface is transverse to a plane defined by the first component surface. The rack includes at least one rack attachment portion coupled to the first component. The first strap portion is removably couplable to a first portion of an automobile, and the second strap portion is removably couplable to a second portion of the automobile. The second portion of the automobile is closer than the first portion of the automobile to a base of the automobile. At least one rack attachment portion is removably couplable to one of the two or more strap attachment portions such that the first component surface faces the strap and the second component extends from the first component away from the strap.

In some implementations, each of the two or more strap attachment portions includes a loop, and each of the at least one rack attachment portions includes a hook.

In some implementations, the plane defined by the second component surface forms an oblique angle with the plane defined by the first component surface.

In some implementations, the first component includes a first portion and a second portion opposite and spaced apart from the first portion, and the second component includes a first end and a second end opposite and spaced apart from the first end. The at least one rack attachment portion is coupled to the first portion of the first component, and the first end of the second component is coupled to the second portion of the first component. In some implementations, the second end of the second component is angled away from the first portion of the first component. In some implementations, the second end of the second component includes a tab extending transverse to the second component surface.

In some implementations, the first portion of the automobile is a top edge of a door of the automobile, and the first strap portion is configured to be removably couplable to the top edge of the door of the automobile when the door is in both an open position and a closed position.

In some implementations, the strap further includes a first hook coupled to the first strap portion. The first hook is couplable to the first portion of the automobile. In some implementations, the first hook has a radius of curvature of 0.5 inches or less.

In some implementations, the second portion of the automobile is a bottom edge of a door of the automobile, and the second strap portion is configured to be removably couplable to the bottom edge of the door of the automobile when the door is in both an open position and a closed position.

In some implementations, the strap further includes a second hook coupled to the second strap portion. The second hook is couplable to the second portion of the automobile. In some implementations, the second hook has a radius of curvature of 0.5 inches or less.

In some implementations, the strap includes an adjustment buckle for changing the distance between the first strap portion and the second strap portion. In some implementations, the adjustment buckle is a cam buckle.

In some implementations, the device further includes a pad coupled to the at least one rack such that the pad abuts at least a portion of the first component surface.

In some implementations, the strap includes a first strap and a second strap. The first strap includes the first strap portion and the second strap includes the second strap portion.

In some implementations, the at least one rack includes two or more racks.

Various other implementations include a storage system for coupling to a side of an automobile. The system includes a first storage device for coupling to a side of an automobile and a second storage device for coupling to a side of an automobile.

In some implementations, the first strap portion of the first device is configured to be removably couplable to a top edge of a door of the automobile when the door is in both an open position and a closed position, and the second strap portion of the first device is configured to be removably couplable to a bottom edge of the door of the automobile when the door is in both an open position and a closed position.

In some implementations, the first strap portion of the second device is configured to be removably couplable to a portion of a bed of the automobile, and the second strap portion of the second device is configured to be removably couplable to a bottom edge of a body of the automobile.

### BRIEF DESCRIPTION OF DRAWINGS

Example features and implementations are disclosed in the accompanying drawings. However, the present disclosure is not limited to the precise arrangements and instrumentalities shown.

FIG. 1 is a perspective view of a storage system for coupling to a side of an automobile, according to one implementation.

FIG. 2 is a perspective view of a first storage device of the storage system of FIG. 1 coupled to a door of the automobile.

FIGS. 3A and 3B are detail perspective views of a first strap portion of the first device of FIGS. 1 and 2 coupled to a top edge of the door of the automobile in an open position and a closed position, respectively.

FIG. 4 is a detail perspective view of a second strap portion of the first device of FIGS. 1 and 2 coupled to a bottom edge of the door of the automobile.

FIG. 5 is a detail perspective view of a rack of the device of FIGS. 1 and 2.

FIG. 6 is a perspective view of a second storage device of the storage system of FIG. 1 coupled to the side of the automobile.

FIG. 7 is a detail perspective view of a first strap portion of the second device of FIGS. 1 and 6 coupled to a bed of the automobile.

### DETAILED DESCRIPTION

The devices, systems, and methods disclosed herein provide for a storage device for coupling to a side of an automobile. In some implementations, the device includes a strap that couples to the top and bottom edges of an automobile door such that the door can still be opened and shut. The device also includes a rack that is adjustably coupled to the strap such that the rack can be positioned at various locations along the strap. The rack includes a portion that extends away from the strap and the automobile. When two or more of the devices are used together as a system, boards, pipes, or other elongated objects can be supported by the extending portions of the racks of the two or more devices.

Various implementations include a storage device for coupling to a side of an automobile. The device includes a strap and at least one rack. The strap has a strap longitudinal axis, a first strap portion, and a second strap portion opposite and spaced apart from the first strap portion along the strap longitudinal axis. The strap includes two or more strap attachment portions spaced apart from each other along the strap longitudinal axis. The at least one rack has a first component defining a first component surface and a second component defining a second component surface. A plane defined by the second component surface is transverse to a plane defined by the first component surface. The rack includes at least one rack attachment portion coupled to the first component. The first strap portion is removably couplable to a first portion of an automobile, and the second strap portion is removably couplable to a second portion of the automobile. The second portion of the automobile is closer than the first portion of the automobile to a base of the automobile. At least one rack attachment portion is removably couplable to one of the two or more strap attachment portions such that the first component surface faces the strap and the second component extends from the first component away from the strap.

Various other implementations include a storage system for coupling to a side of an automobile. The system includes a first storage device for coupling to a side of an automobile and a second storage device for coupling to a side of an automobile.

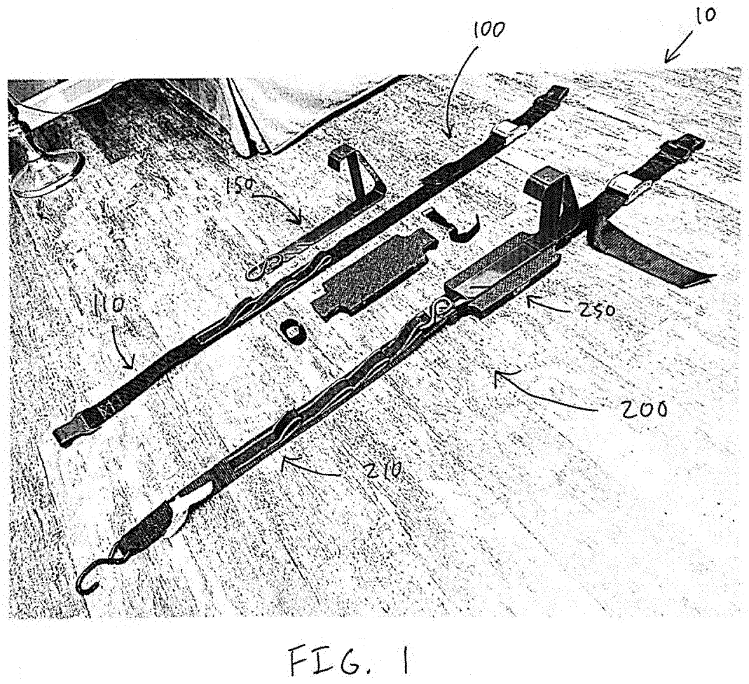

FIG. 1 a storage system 10 for coupling to a side 910 of an automobile 900. The system 10 includes a first storage device 100 for coupling to a side of an automobile and a second storage 200 device for coupling to a side of an automobile.

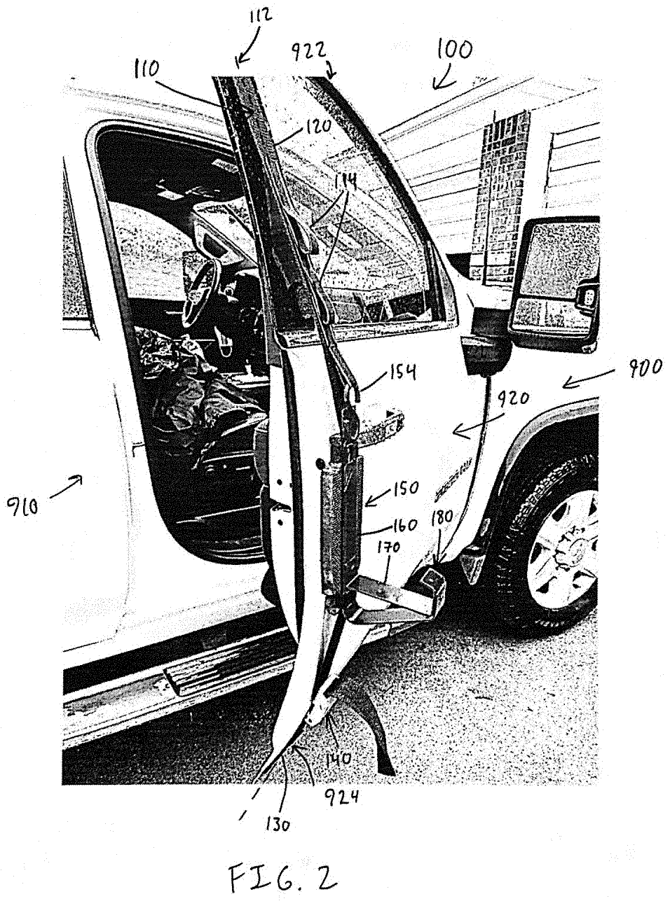

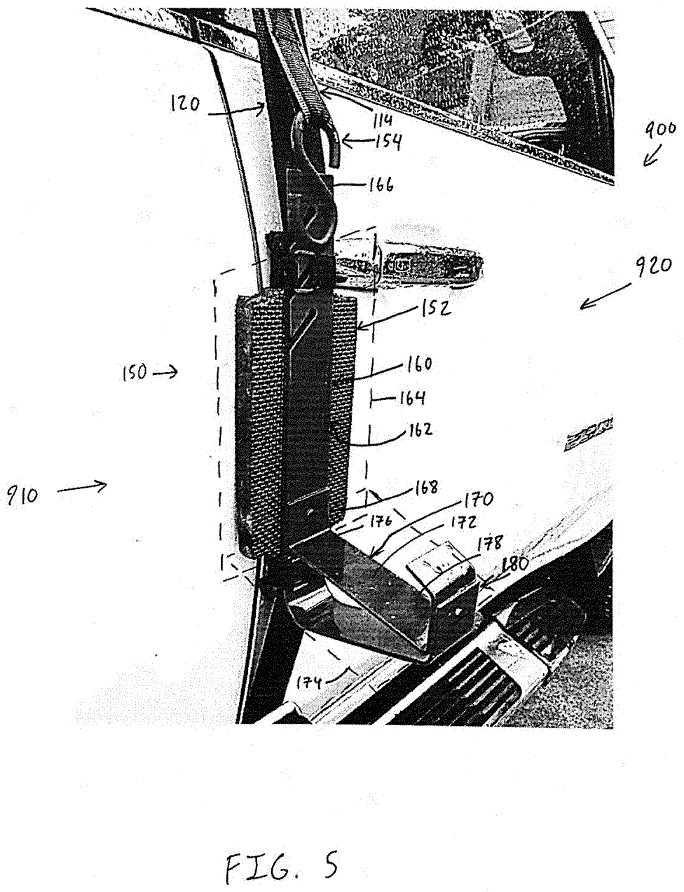

FIGS. 2-5 show the first storage device 100 for coupling to a side 910 of an automobile 900. The device 100 includes a strap 110 and a rack 150.

The strap 110 includes a first strap 120 and a second strap 130. The strap 110 also includes a strap longitudinal axis 112 running along the length of the first strap 120 and the second strap 130. The first strap 120 includes a first strap portion 122, and the second strap 130 includes a second strap portion 132. The first strap portion 122 and the second strap portion 132 are opposite and spaced apart from each other along the strap longitudinal axis 112.

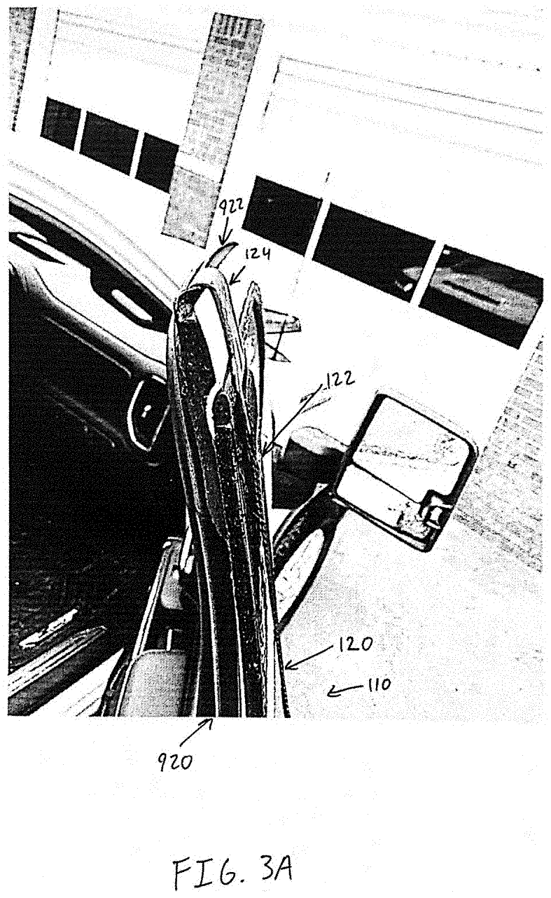

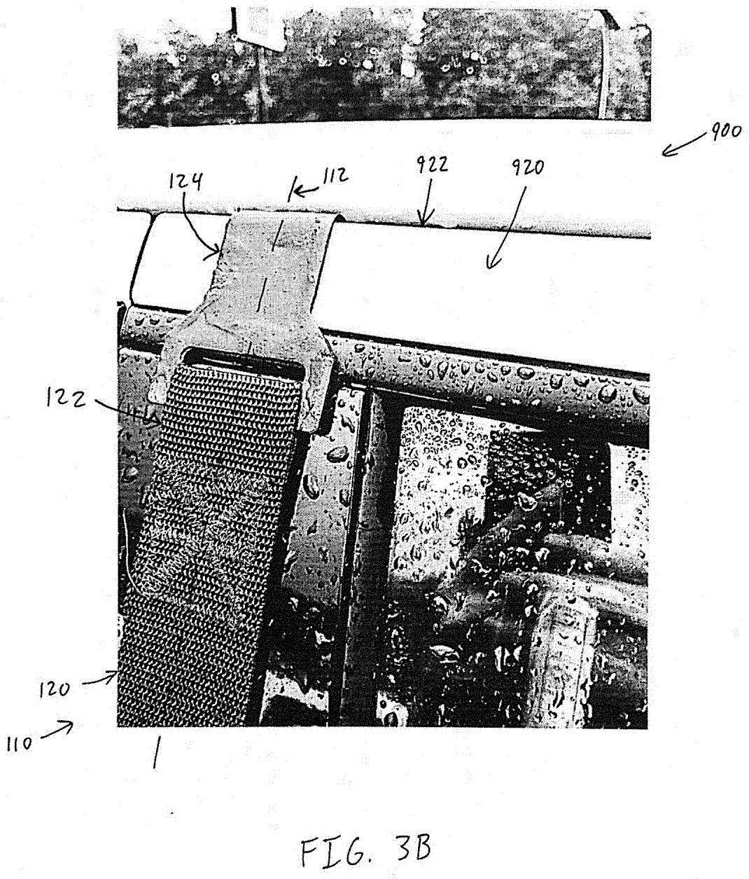

FIGS. 2-4 show the strap 110 of the first device 100. The strap 110 includes a first hook 124 coupled to the first strap portion 122, as shown in FIGS. 3A and 3B. The first hook 124 is sized and shaped to be removably couplable to a top edge 922 of a door 920 of an automobile 900 when the door 920 is in both an open position (shown in FIG. 3A) and a closed position (shown in FIG. 3B). The first hook 124 shown in FIGS. 3A and 3B has a radius of curvature of 0.5 inches, but in other implementations, the first hook can have a radius of curvature of any size of more or less than 0.5 inches, including 0.125 inches, 0.25 inches, 0.375 inches, 0.625 inches, 0.75 inches, 0.875 inches, or 1.0 inch. In some implementations, the first hook can be any size and shape such that the first hook is couplable to a top edge of a door of an automobile when the door is in both an open position and a closed position. In some implementations, the first hook is sized and shaped to be removably couplable to any other first portion of an automobile. In some implementations, the strap does not include a first hook. In some implementations, the first strap portion includes any other coupler capable of being removably couplable to a top edge of a door of an automobile when the door is in both an open position and a closed position or to any other first portion of an automobile.

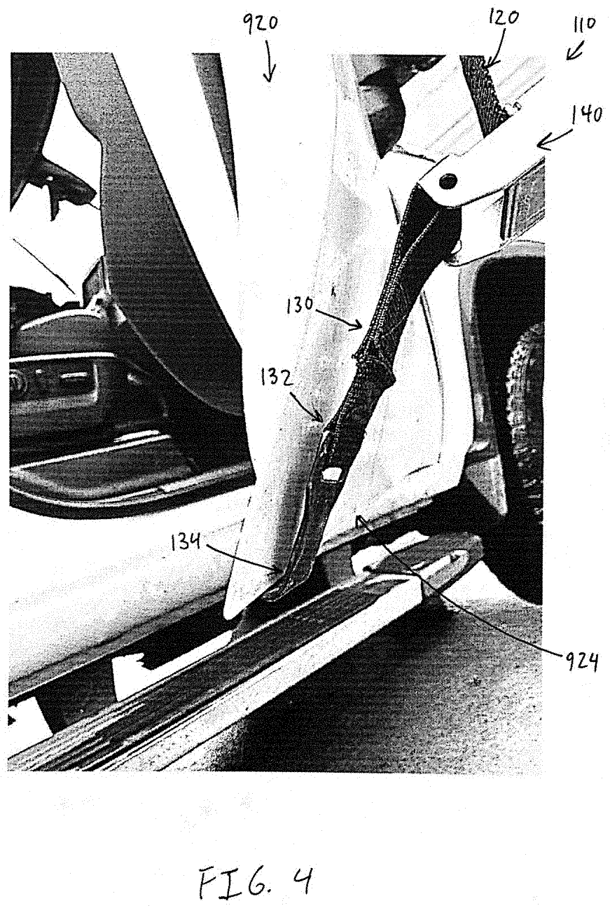

The strap 110 further includes a second hook 134 coupled to the second strap portion 132, as shown in FIG. 4. The second hook 134 is sized and shaped to be removably couplable to a bottom edge 924 of a door 920 of an automobile 900 when the door 920 is in both an open position and a closed position. The second hook 134 shown in FIG. 4 has a radius of curvature of 0.5 inches, but in other implementations, the second hook can have a radius of curvature of any size of more or less than 0.5 inches, including 0.125 inches, 0.25 inches, 0.375 inches, 0.625 inches, 0.75 inches, 0.875 inches, or 1.0 inch. In some implementations, the second hook can be any size and shape such that the second hook is couplable to a bottom edge of a door of an automobile when the door is in both an open position and a closed position. In some implementations, the second hook is sized and shaped to be removably couplable to any other second portion of an automobile. In some implementations, the strap does not include a second hook. In some implementations, the second strap portion includes any other coupler capable of being removably couplable to a bottom edge of a door of an automobile when the door is in both an open position and a closed position or to any other second portion of an automobile that is closer than the first portion of the automobile to a base of the automobile.

The strap 110 also includes an adjustment buckle 140 adjustably coupled to the first strap 120 and the second strap 130, as shown in FIGS. 2 and 4. The first strap 120 can be adjustably slid through the adjustable buckle 140 to change the distance between the first strap portion 122 and the second strap portion 132 as measured along the strap longitudinal axis 112. The adjustable buckle 140 shown in FIGS. 2 and 4 is a cam buckle, but in other implementations, the adjustable buckle can be any other type of buckle or any device capable of adjustably coupling the first strap to the second strap.

In implementations in which the strap is a single strap (rather than including a first strap portion and a second strap portion), the adjustable buckle can be directly coupled to one of the first hook or the second hook, to any other coupler of the first strap portion or the second strap portion, or to a center portion of the strap such that the adjustable buckle can change the distance between the first strap portion and the second strap portion as measured along the strap longitudinal axis.

The strap 110 includes two or more strap attachment portions 114 spaced apart from each other along the strap longitudinal axis 112, as shown in FIGS. 1 and 2. Each of the two or more strap attachment portions 114 includes a loop for coupling the rack 150 to the strap 110, as discussed below.

The rack 150 shown in FIGS. 1, 2, and 5 includes a first component 160 and a second component 170. The first component 160 defines a first component surface 162, and the second component 170 defines a second component surface 172. A plane 174 defined by the second component surface 172 is transverse to a plane 164 defined by the first component surface 162. The first component 160 includes a first portion 166 and a second portion 168 opposite and spaced apart from the first portion 166, and the second component 170 includes a first end 176 and a second end 178 opposite and spaced apart from the first end 176. The first end 176 of the second component 170 is coupled to the second portion 168 of the first component 160 such that the second end 178 of the second component 170 is angled away from the first portion 166 of the first component 160 and the plane 174 defined by the second component surface 172 forms an oblique angle with the plane 164 defined by the first component surface 162. The second end 178 of the second component 170 includes a tab 180 extending transverse to the second component surface 174.

The rack 150 includes a rack attachment portion 154 coupled to the first portion 166 of the first component 160. The rack attachment portion 154 includes a hook configured to be removably couplable to one of the two or more strap attachment portions 114 of the strap 110 such that the first component surface 162 faces the strap 110, and the second component 170 extends from the first component 160 away from the strap 110. The rack attachment portion 154 can be removably coupled to any of the two or more strap attachment portions 114 of the strap 110 to allow for adjustability of the rack 150 along the strap longitudinal axis 112. The loop and hook design of the strap attachment portions 114 and rack attachment portion 154, respectively, provides for quick adjustment along with reliable and strong couplings that do not move during use.

Although the rack 150 shown in FIGS. 1, 2, and 5 includes only one rack attachment portion 154, in other implementations, the rack includes two or more rack attachment portions and each of the two or more rack attachment portions is removably couplable to a separate or the same strap attachment portion. Although the rack attachment portion 154 of the rack 150 shown in FIGS. 1, 2, and 5 is coupled to the first portion 166 of the first component 160 of the rack 150, in other implementations, the rack attachment portion is coupled to any portion of the first component.

The first component 160 of the rack 150 further includes a pad 152 coupled to and abutting the first component surface 162. The pad 152 cushions the rack 150 and/or strap 110 against the side 910 of the automobile 900 to protect the automobile 900 from being damaged by the device 100 during use.

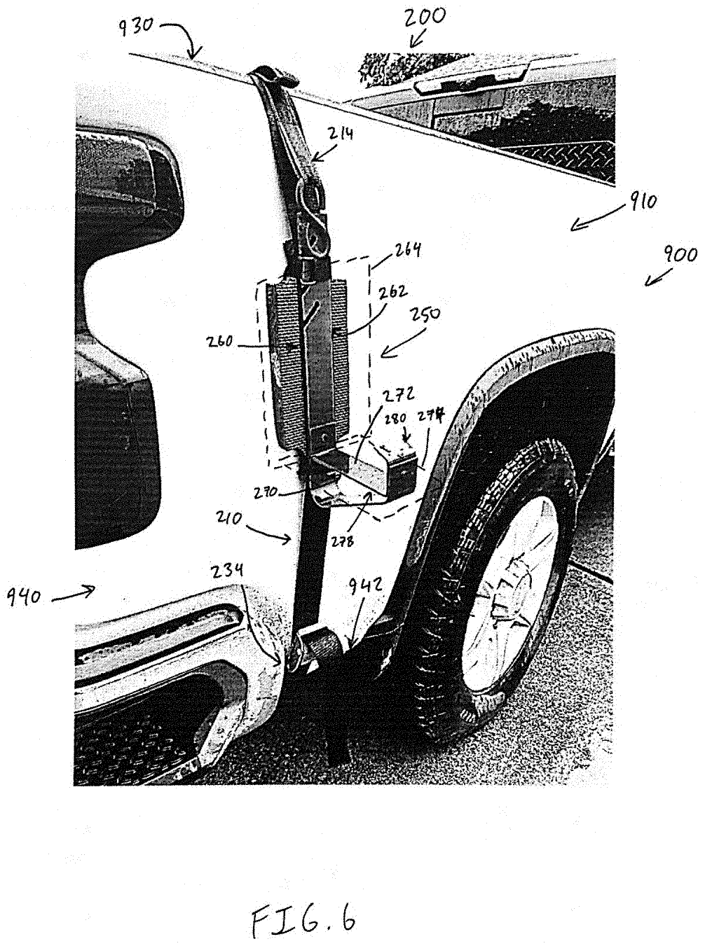

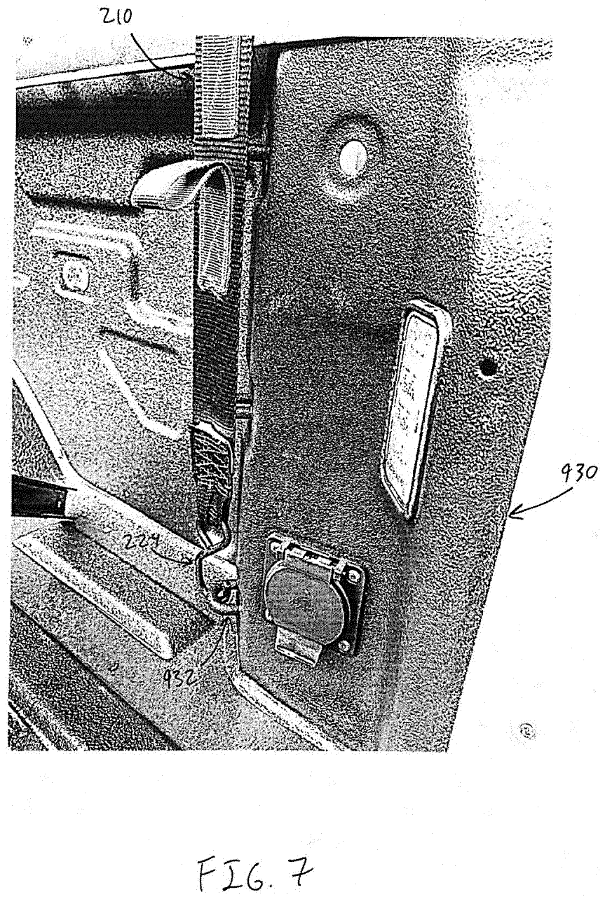

FIGS. 6 and 7 show the second storage device 200 for coupling to a side 910 of an automobile 900. The second storage device 200 shown in FIGS. 6 and 7 includes similar features to the device 100 shown in FIGS. 2-5, so similar reference numbers to those used for features of the device 100 shown in FIGS. 2-5 are used for labeling similar features of the device 200 shown in FIGS. 6 and 7. The device 200 shown in FIGS. 6 and 7 differs from the device 100 shown in FIGS. 2-5 in that the device 200 of FIGS. 6 and 7 does not include a first hook sized and shaped to be removably couplable to a top edge of a door of an automobile or a second hook sized and shaped to be removably couplable to a bottom edge of a door of an automobile. Instead, the device 200 shown in FIGS. 6 and 7 includes a first hook 224 that is sized and shaped to be removably couplable to an anchor point loop 932 in the bed 930 of the automobile 900 and a second hook 234 that is sized and shaped to be removably couplable to a bottom portion 942 of the body 940 of the automobile 900.

Although the second storage device 200 shown in FIGS. 6 and 7 includes first and second hooks 224, 234 that are removably couplable to the bed 930 and the body 940 of the automobile 900, in other implementations, the first and second hooks are configured to be removably couplable to any portions of the automobile.

The implementation of the system 10 shown in FIGS. 1-7 shows devices 100, 200 that each include one rack 150, 250 removably coupled to a strap 110, 210, but in other implementations, the devices each include two or more racks removably coupled to a single strap.

The racks 150, 250 of the first device 100 and the second device 200 of the system 10 can be coupled to strap attachment portions 114, 214 of their respective straps 110, 210 such that the second component surfaces 172, 272 of the racks 150, 250 are substantially level with each other relative to the automobile 900 to which the devices 100, 200 are coupled. With the second component surfaces 172, 272 of the racks 150, 250 substantially level with each other, boards, pipes, or other elongated objects can be supported by the extending second components 170, 270 of the racks 150, 250 of the two or more devices 100, 200.

Because the planes 174, 274 defined by the second component surfaces 172, 272 of the racks 150, 250 form oblique angles with the planes 164, 264 defined by the first component surfaces 162, 262 of the racks 150, 250, gravity causes the boards, pipes, or other elongated objects to move toward the second ends 178, 278 of the second components 170, 270 when the boards, pipes, or other elongated objects are supported by the racks 150, 250. The tabs 180, 280 extending from the second ends 178, 278 of the second components 170, 270 and transverse to the second component surfaces 172, 272 prevent the boards, pipes, or other elongated objects from moving beyond the second ends 178, 278 of the racks 150, 250 and from falling from the devices 100, 200. These objects can also be tied or otherwise coupled to the racks 150, 250 of the first and second devices 100, 200 to prevent the objects from falling off of the second component surfaces 172, 272 of the racks 150, 250.

Because the first and second hooks 124, 134 of the strap 110 of the first device 100 are configured to be coupled to the top and bottom edges 922, 924 of the door 920 of an automobile 900, respectively, the door 920 to which the first device 100 is coupled can be opened and closed with the device 100 coupled to it. Thus, when the racks 150, 250 are not being used to support boards, pipes, or other elongated objects, the door 920 can still be used without needing to remove the first device 100.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

What is claimed is:

1. A storage device for coupling to a side of an automobile, the device comprising:
a strap having a strap longitudinal axis, a first strap portion, and a second strap portion opposite and spaced apart from the first strap portion along the strap longitudinal axis, wherein the strap includes two or more strap attachment portions spaced apart from each other along the strap longitudinal axis;
at least one rack having a first component defining a first component surface and a second component defining a second component surface, wherein a plane defined by the second component surface is transverse to a plane defined by the first component surface, wherein the rack includes at least one rack attachment portion coupled to the first component,
wherein the first strap portion is removably couplable to a first portion of an automobile, and the second strap portion is removably couplable to a second portion of the automobile, wherein the second portion of the automobile is closer than the first portion of the automobile to a base of the automobile, and
wherein at least one rack attachment portion is removably couplable to one of the two or more strap attachment portions such that the first component surface faces the strap and the second component extends from the first component away from the strap.

2. The device of claim 1, wherein each of the two or more strap attachment portions includes a loop, and each of the at least one rack attachment portions includes a hook.

3. The device of claim 1, wherein the plane defined by the second component surface forms an oblique angle with the plane defined by the first component surface.

4. The device of claim 1, wherein the first component includes a first portion and a second portion opposite and spaced apart from the first portion, and the second component includes a first end and a second end opposite and spaced apart from the first end, wherein the at least one rack attachment portion is coupled to the first portion of the first component, and the first end of the second component is coupled to the second portion of the first component.

5. The device of claim 4, wherein the second end of the second component is angled away from the first portion of the first component.

6. The device of claim 4, wherein the second end of the second component includes a tab extending transverse to the second component surface.

7. The device of claim 1, wherein the first portion of the automobile is a top edge of a door of the automobile, and the first strap portion is configured to be removably couplable to the top edge of the door of the automobile when the door is in both an open position and a closed position.

8. The device of claim 1, wherein the strap further includes a first hook coupled to the first strap portion, wherein the first hook is couplable to the first portion of the automobile.

9. The device of claim 8, wherein the first hook has a radius of curvature of 0.5 inches or less.

10. The device of claim 1, wherein the second portion of the automobile is a bottom edge of a door of the automobile, and the second strap portion is configured to be removably couplable to the bottom edge of the door of the automobile when the door is in both an open position and a closed position.

11. The device of claim 1, wherein the strap further includes a second hook coupled to the second strap portion, wherein the second hook is couplable to the second portion of the automobile.

12. The device of claim 11, wherein the second hook has a radius of curvature of 0.5 inches or less.

13. The device of claim 1, wherein the strap includes an adjustment buckle for changing the distance between the first strap portion and the second strap portion.

14. The device of claim 13, wherein the adjustment buckle is a cam buckle.

15. The device of claim 1, further comprising a pad coupled to the at least one rack such that the pad abuts at least a portion of the first component surface.

16. The device of claim 1, wherein the strap includes a first strap and a second strap, wherein the first strap includes the first strap portion and the second strap includes the second strap portion.

17. The device of claim 1, wherein the at least one rack includes two or more racks.

18. A storage system for coupling to a side of an automobile, the system comprising a first device according to claim 1 and a second device according to claim 1.

19. The system of claim 18, wherein the first strap portion of the first device is configured to be removably couplable to a top edge of a door of the automobile when the door is in both an open position and a closed position, and the second strap portion of the first device is configured to be removably couplable to a bottom edge of the door of the automobile when the door is in both an open position and a closed position.

20. The system of claim 19, wherein the first strap portion of the second device is configured to be removably couplable to a portion of a bed of the automobile, and the second strap portion of the second device is configured to be removably couplable to a bottom edge of a body of the automobile.
